(19) United States
(12) Patent Application Publication
(10) Pub. No.: US 2006/0087684 A1
(43) Pub. Date: Apr. 27, 2006

(54) Communication terminal device

(75) Inventor: Kenji Dokuni, Kyoto-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/228,643

(22) Filed: Sep. 16, 2005

(30) Foreign Application Priority Data
Oct. 22, 2004 (JP) 2004-307729

(51) Int. Cl. G06F 3/12

(52) U.S. Cl. 358/1.15

(57) ABSTRACT

A communication terminal device, which is connected to a file server via a network in a manner that communication can be carried out, manages an image file transmitted from at least one communication terminal device including the communication terminal device itself and stored in the file server.

### BACKGROUND OF THE INVENTION

1. Field of the Invention

The present invention relates to a communication terminal device, and in particular, relates to a communication terminal device connected to a file server via a network in a manner that communication can be carried out.

The present invention is applicable to a communication terminal device, which stores an image file into a file server connected via a network.

2. Description of Related Art

There exists a system in which at least one communication terminal device and a file server are connected via a network, such as a Local Area Network (LAN), in a manner that communication can be carried out. Further, the communication terminal device may be a Multi Function Peripheral (MFP) having a plurality of functions, such as a copy function and a fax transmission and reception function. In such a system, the file server is used as storage for storing an image file of image data, which is scanned from an original document by the communication terminal device, or an image file of image data, which is transmitted or received by fax. Therefore, by establishing such a system, an image file can be transmitted from the at least one communication terminal device to the file server, and the image file can be stored in the file server. As a result, a uniform management of the image file can be carried out.

In the above-described system, there exists a conventional communication terminal device, which manages the image file stored in the file server. Such a conventional communication terminal device previously stores information, which relates to the image file transmitted to the file server, in the communication terminal device itself. The communication terminal device periodically searches whether or not a storage deadline of the image file stored in the file server has expired in accordance with the stored information. Then, the communication terminal device determines whether or not it is necessary to store the image file, which is past the storage deadline. When a determination is made that the image file is necessary to be stored, such an image file is transmitted to a remote storage device, and the image file stored in the file server, which is past the storage deadline, is deleted. The image file stored in the file server is managed in the above-described manner.

However, according to the above-described conventional communication terminal device, with respect to an image file that has been stored into the file server by the communication terminal device itself, information relating to such an image file is stored in the communication terminal device itself. Therefore, the communication terminal device can carry out a management of such an image file. However, with respect to an image file that has been stored into the file server by another communication terminal device, information relating to such an image file is not stored in the communication terminal device itself. Therefore, the communication terminal device cannot carry out a management of such an image file.

### SUMMARY OF THE INVENTION

The present invention has been made in consideration of the above-described circumstances. An advantage of the present invention is to provide a communication terminal device connected to a file server via a network in a manner that communication can be carried out, and more particularly, a communication terminal device capable of managing an image file, which has been transmitted from one or a plurality of communication terminal devices including the communication terminal device itself and stored into the file server.

According to a first aspect of the present invention, a communication terminal device is connected to a file server via a network. Further, the file server stores an image file and attribute information of the image file by associating one with another. The communication terminal device includes a storage unit, a first requesting unit, a reception unit, a generation unit and a second requesting unit. The storage unit stores a first extraction condition and a second extraction condition. The first requesting unit requests the file server to transmit a first list with attribute information of an image file corresponding to the first extraction condition, when a preset request date and time arrives. The reception unit receives the first list transmitted from the file server according to the request. The generation unit extracts information specifying an image file corresponding to the second extraction condition from the received first list, and generates a second list in which the extracted information is written. The second requesting unit requests the file server to execute a prescribed processing on the image file specified by the generated second list.

According to a second aspect of the present invention, the second requesting unit requests the file server to execute a deletion processing on the image file specified by the generated second list.

According to a third aspect of the present invention, the second requesting unit requests the file server to execute a download processing on the image file specified by the second list generated by the generation unit. The reception unit receives an image file transmitted from the file server according to the request of the second requesting unit, in addition to the first list.

According to a fourth aspect of the present invention, the communication terminal device further includes a printer unit, which prints an image of the image file received by the reception unit onto paper.

According to a fifth aspect of the present invention, the communication terminal device further includes an accepting unit, which accepts a designation of the first extraction condition and the second extraction condition. The storage unit stores the first extraction condition and the second extraction condition accepted by the accepting unit.

According to the first aspect, the communication terminal device can automatically acquire the first list with the attribute information of the image file (information relating to the image file), which has been transmitted from one or a plurality of communication terminal devices including the communication terminal device itself and stored into the file server. Moreover, the communication terminal device extracts the information specifying the image file corresponding to the second extraction condition from the first list, and requests the file server to execute a prescribed processing on the image file specified by the second list with the extracted information. Therefore, the file server is not required to distinguish an image file to be executed with a prescribed processing. Thus, without correcting a program of the file server so as to execute a prescribed processing or without installing a program for executing a prescribed processing, a prescribed processing can be executed by the file server on the image file specified by the second list.

According to the second aspect, the communication terminal device can automatically delete the image file stored in the file server without requiring a user to carry out an operation.

According to the third aspect, the communication terminal device can automatically download the image file stored in the file server without requiring a user to carry out an operation.

According to the fourth aspect, since the image of the received image file is printed out onto paper, the user can acquire printed paper on which an image of a necessary image file is printed without carrying out an operation by the user itself.

According to the fifth aspect, since the user can designate the first extraction condition and the second extraction condition, the communication terminal device can automatically carry out processes, such as deleting an unnecessary image file and downloading an image file, which has been stored into the file server by another communication terminal device, to the communication terminal device itself.

### BRIEF DESCRIPTION OF THE SEVERAL VIEWS OF THE DRAWINGS

FIG. 1 is a block diagram showing an example of a configuration of a communication terminal device according to an embodiment of the present invention.

FIG. 2 is a block diagram showing a state in which a communication terminal device and a file server are connected via a LAN according to an embodiment of the present invention.

FIG. 3 shows an example of a file list.

FIG. 4 is a flowchart showing a processing operation carried out by the communication terminal device when a request processing is a “deletion processing”.

FIG. 5 shows an example of a first list transmitted from the file server.

FIG. 6 shows an example of a second list generated by the communication terminal device.

FIG. 7 shows an example of a second list generated by the communication terminal device.

FIG. 8 shows an example of a second list generated by the communication terminal device.

FIG. 9 is a flowchart showing a part of a processing operation carried out by the communication terminal device when a request processing is a “download processing”.

### DETAILED DESCRIPTION OF THE INVENTION

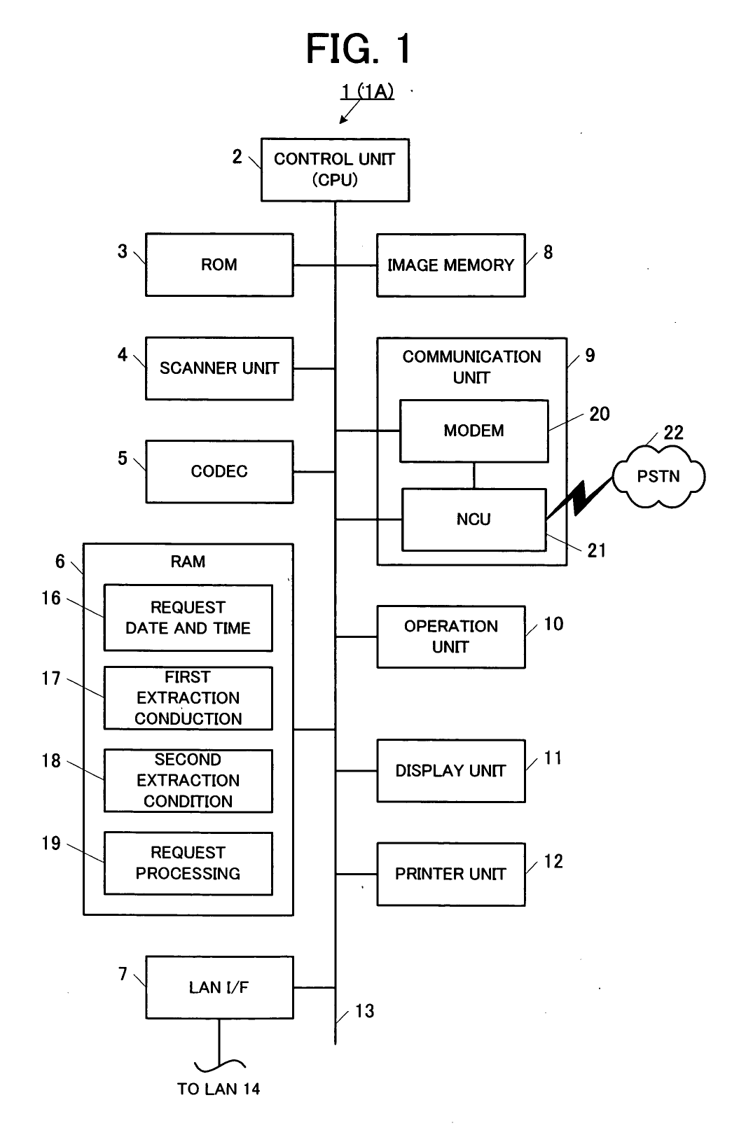

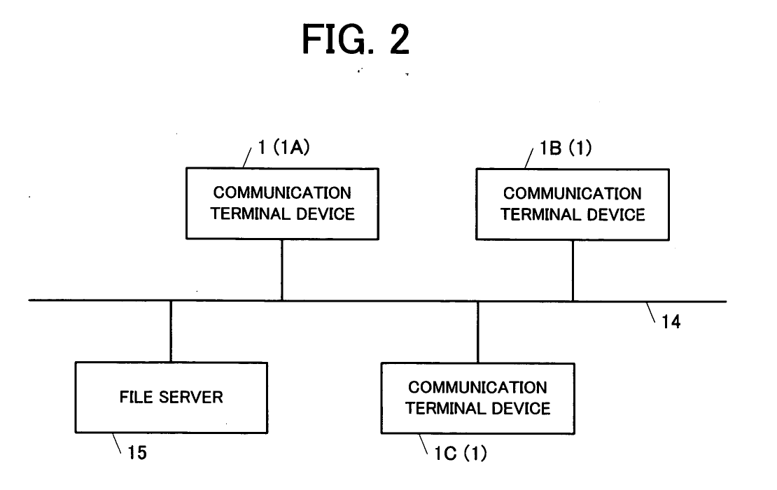

With reference to the drawings, a description will be made of a communication terminal device according to an embodiment of the present invention. FIG. 1 is a block diagram showing an example of a configuration of a communication terminal device 1 (1A) according to an embodiment of the present invention. As shown in FIG. 1, the communication terminal device 1 includes a control unit (Central Processing Unit (CPU)) 2, a Read Only Memory (ROM) 3, a scanner unit 4, a Coder and Decoder (CODEC) 5, a Random Access Memory (RAM) 6, a LAN Interface (I/F) 7, an image memory 8, a communication unit 9, an operation unit 10, a display unit 11 and a printer unit 12. Each of the units 2 through 12 is connected via a bus 13 in a manner that communication can be carried out. As shown in FIG. 2, other than the communication terminal device 1 (1A), communication terminal devices 1B (1) and 1C (1) having the same configuration as the communication terminal device 1 are connected to a LAN 14. The communication terminal devices 1A through 1C can carry out communication with a file server 15 via the LAN 14.

The control unit 2 controls each of the units of the communication terminal device 1. The ROM 3 stores a control program for controlling each of the units of the communication terminal device 1 by the control unit 2.

The scanner unit 4 scans image data of an original document. Although not shown in the drawing, the scanner unit 4 includes a Flat Bed Scanner (FBS) and an Automatic Document Feeder (ADF) for scanning image data of an original document. The FBS has a transparent document placing table, where an original document is placed, and a transparent light-penetrating plate, where an original document transported by the ADF passes over. Original documents placed on a document tray of the ADF are sequentially transported one sheet at a time over the light-penetrating board. An image of the original document is scanned by a Charge-Coupled Device (CCD) line sensor, which is provided in the FBS. Then, the scanned image is output as image data. Further, image data of the original document placed on the document placing table can be scanned also by the CCD line sensor.

The CODEC 5 has a function for encoding and decoding image data by a method such as the Modified Huffman (MH), the Modified READ (MR), the Modified Modified READ (MMR), the Joint Bi-level Image Group (JBIG) and the Joint Photographic Experts Group (JPEG). The CODEC 5 encodes the image data of the original document scanned by the scanner unit 4. The CODEC 5 also decodes encoded image data. Moreover, the CODEC 5 also encodes or decodes image data according the Tagged Image File Format (TIFF) or the Portable Document Format (PDF), which are image formats generally used by a computer.

The RAM 6 functions as a main memory and a working area or the like of the control unit 2. The RAM 6 retrieves setting information or operation information, etc. to be used in a processing operation of the communication terminal device 1. In addition, the RAM 6 stores such pieces of information under a writable form. Specifically, the RAM 6 stores a request date and time 16, a first extraction condition 17, a second extraction condition 18 and a request processing 19. The request date and time 16 is any date and time when requesting the file server 15 to transmit a first list. The request date and time 16 is set previously from the operation unit 10 by a user. Further, the first list is a list formed by extracting attribute information of an image file corresponding to the first extraction condition 17 from a file list in which attribute information of an image file stored in the file server 15 is written (stored), and writing the extracted attribute information into the list. Although a detail will be described later, the attribute information of the image file is information of “serial number”, “file name/subject name”, “type”, “destination”, “date and time”, “size”, “terminal name”, “level of importance” and “path” relating to such an image file. By previously setting the request date and time 16, the communication terminal device 1 can periodically acquire the first list.

The first extraction condition 17 is a condition for extracting attribute information of an image file, which the user of the communication terminal device 1 needs, from the file list by the file server 15. The first extraction condition 17 is transmitted to the file server 15 as a Structured Query Language (SQL) command character string, along with a transmission request of the first list. The second extraction condition 18 is a condition for extracting information specifying an image file, which requests the file server 15 to execute the request processing 19, from the first list by the control unit 2.

The request processing 19 is a processing, which is requested to be executed by the file server 15 on an image file specified by a second list. The second list is a list formed by extracting information specifying an image file corresponding to the second extraction condition 18 from the first list, and writing the extracted information into the list. The control unit 2 generates the second list in the RAM 6. The RAM 6 can store a plural number of first extraction conditions 17, second extraction conditions 18 and request processing 19, respectively. The user can designate either one of the plural number of the first extraction conditions 17, the second extraction conditions 18 and the request processing 19 and set as the first extraction condition 17, the second extraction condition 18 and the request processing 19. Further, in the present embodiment, as the request processing 19, a description will be made of an example of a “deletion processing” for deleting an image file specified by the second list and a “download processing” for transmitting an image file specified by the second list to the communication terminal device 1, which requested the image file. However, the request processing 19 shall not be limited to these examples.

The control unit 2 can store the first extraction condition 17 into the RAM 6 in accordance with a text file imported from a Personal Computer (PC) (not shown) provided on the network. Specifically, the control unit 2 imports from the PC, a text file in which the first extraction condition 17 is described in a prescribed format. The control unit 2 analyzes the text file and creates a SQL command character string in which the first extraction command 17 is described. Then, the control unit 2 stores the created SQL command character string into the RAM 6 as a text file. As described above, the user can store the first extraction condition 17 into the RAM 6 as a text file of the SQL command character string. The control unit 2 can export to the PC, the first extraction condition 17 stored in the RAM 6 as the text file.

The LAN I/F 7 is an interface for establishing a connection between the LAN 14 and the communication terminal device 1 in a manner that communication can be carried out. The communication terminal device 1 is connected to the file server 15 on the LAN 14 via the LAN I/F 7 in a manner that communication can be carried out. The image memory 8 stores, for example, image data encoded by the CODEC 5. The image memory 8 can also store an image file transmitted from the file server 15.

Although not shown in the drawing, a mail server and a router or the like are also provided on the LAN 14. The communication terminal device 1 can carry out Internet facsimile communication for transmitting and receiving electronic mail attached with image data of an original document with another Internet facsimile machine (not shown) or the like through the mail server, the router, the Internet or the like.

The communication unit 9 includes a Modulator-Demodulator (MODEM) 20 and a Network Control Unit (NCU) 21. The MODEM 20 modulates and demodulates transmitted or received data in accordance with, for example, the International Telecommunication Union Telecommunication Standardization Sector (ITU-T) Recommendation V.34 standard or anything similar to this. The NCU 21 is a communication line network control device, which controls a telephone line to make or hang a telephone call. The NCU 21 is connected to a Public Switched Telephone Network (PSTN) 22. The communication unit 9 functions when carrying out fax transmission or reception of an image data of an original document.

The operation unit 10 includes a cursor key for entering various pieces of setting information of the communication terminal device 1, and various operation keys for entering a command such as a scan command and a fax transmission command. The operation unit 10 operates in synchronism with the display unit 11. The user operates the operation unit 10 for setting the request date and time 16 and for designating the first extraction condition 17, the second extraction condition 18 and the request processing 19.

The display unit 11 includes a Liquid Crystal Display (LCD) and a Light Emitting Diode (LED) lamp or the like. The display unit 11 displays various setting screens and an operation status or the like of the communication terminal device 1 by using a character, a figure and light or the like. The LCD of the display unit 11 may be formed as a touch screen, and instead of operating the operation unit 10, various settings and commands or the like of the communication terminal device 1 may be entered from the display unit 11. The printer unit 12 prints an image of the image data retrieved from the image memory 8 onto paper. As a printing method of the printer unit 12, for example, various printing methods, such as an electrophotographic method and an inkjet printing method, may be adopted.

Meanwhile, the file server 15 provided on the LAN 14 is a PC having general functions. The file server 15 stores image files transmitted from the communication terminal devices 1A, 1B and 1C, and a file list with attribute information of the image files. For example, an image file transmitted from the communication terminal device 1 to the file server 15 is a file of the image data of the original document scanned by the scanner unit 4 of the communication terminal device 1, or a file of the image data of the original document transmitted or received by fax between the communication terminal device 1 and a remote device. Alternatively, an image file transmitted from the communication terminal device 1 to the file server 15 may be an image file attached to electronic mail transmitted or received by the Internet facsimile communication between the communication terminal device 1 and a remote communication terminal device. Further, the file server 15 may be a MFP having facsimile function and a copy function or the like.

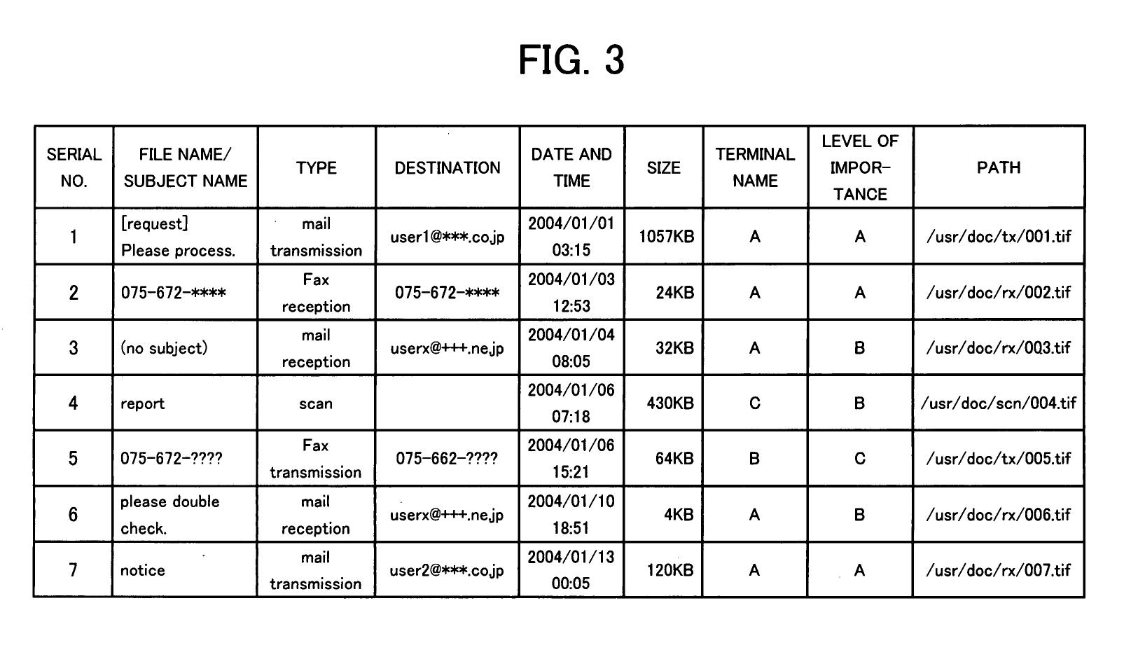

FIG. 3 shows an example of a file list stored in the file server 15. For each record, the file list has nine fields: “serial number”, “file name/subject name”, “type”, “destination”, “date and time”, “size”, “terminal name”, “level of importance” and “path”. The “serial number” field stores serial numbers assigned to each stored image file. The “file name/subject name” field stores a file name of an image file, a subject name of electronic mail with an image file attachment, or a fax number of a destination an image file transmitted or received by fax. Information received along with an image file or information applied by the file server 15 at transmission of the image file from the communication terminal device 1 to the file server 15 is written into the “file name/subject name” field. Further, a rule of information written into the “file name/subject name” field is not limited to the above-described examples.

The “type” field stores information indicating a method for acquiring an image file by the communication terminal device 1. For example, information such as “mail transmission”, “mail reception”, “Fax transmission”, “Fax reception” and “scan” by the scanner unit 4 are written. The “destination” field stores a fax number of a device of other party of fax transmission or reception of the image file, and electronic mail address of a device of other party of transmission or reception of electronic mail with an image file attachment. The “date and time” field stores year, month, date, hour and minute when the processing written in the “type” field was executed. The “size” field stores a data size of an image file. The “terminal name” field stores a name of the communication terminal device 1, which is a transmitter of the image file transmitted to the file server 15. For example, when the image file has been transmitted from the communication terminal device 1A, “A” is written. The “level of importance” field stores information indicating a level of importance of the image file. Further, the information indicating the level is assigned by the communication terminal device 1, which is the transmitter. “A” is the most important level in the “level of importance”. The level descends in an alphabetical order. The “path” field stores information indicating where the image file is stored in the file server 15.

For example, as shown in FIG. 3, a record having “1” in the “serial number” field indicates that the terminal “A” (the communication terminal device 1A) carried out “transmission” of electronic mail having a subject name “[request] Please process.” with a “1057 KB” image file attachment to an electronic mail address “user1@***.co.jp” on “Jan. 1, 2004 3:15 AM”. In addition, the record having “1” in the “serial number” field indicates that the image file transmitted from the terminal “A” to the file server 15 is stored as “001.tif” in “/usr/doc/tx/” of a Hard Disk (HD) after the transmission, and that the level of importance of the image file is “A”.

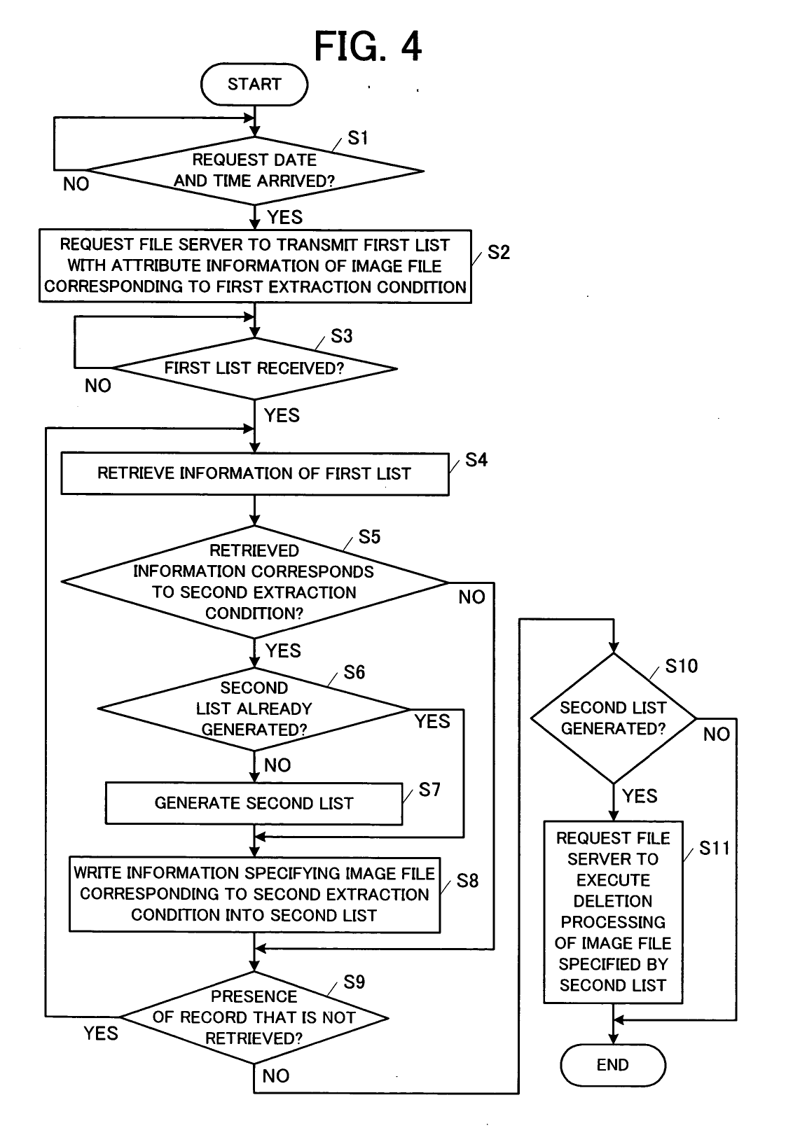

Next, with reference to the flowchart of FIG. 4, a description will be made of a processing operation carried out when the request date and time 16 arrives. The description will be made with reference to an example of a case where in the above-described communication terminal device 1 (1A), the user sets the request date and time 16 at “0:00 AM everyday”, the first extraction condition 17 is designated to extract “attribute information of an image file, which has been stored into the file server 15 by own device (the terminal “A”: the communication terminal device 1A)”, the second extraction condition 18 is designated to extract “information specifying an image file received by electronic mail” from the first list, and the request processing 19 is designated to execute a “deletion processing” of an image file specified by the second list. The file server 15 is assumed to be storing the file list shown in FIG. 3 and an image file corresponding to the attribute information written in the file list shown in FIG. 3. Further, the processing operation of each of the units of the communication terminal device 1A is carried out in accordance with a control command generated by the control unit 2 based on a control program stored in the ROM 3.

First, the control unit 2 determines whether or not the request date and time 16 preset by the user has arrived (step S1) Specifically, a determination is made as to whether or not a present time is “0:00 AM”. When a determination is made that the request date and time 16 has arrived (step S1: YES), the control unit 2 requests the file server 15 to transmit the first list with the attribute information of the image file corresponding to the first extraction condition 17 (step S2). That is, the control unit 2 transmits to the file server 15, the first extraction condition 17 and a command requesting the transmission of the first list with the attribute information of the image file corresponding to the first extraction condition 17.

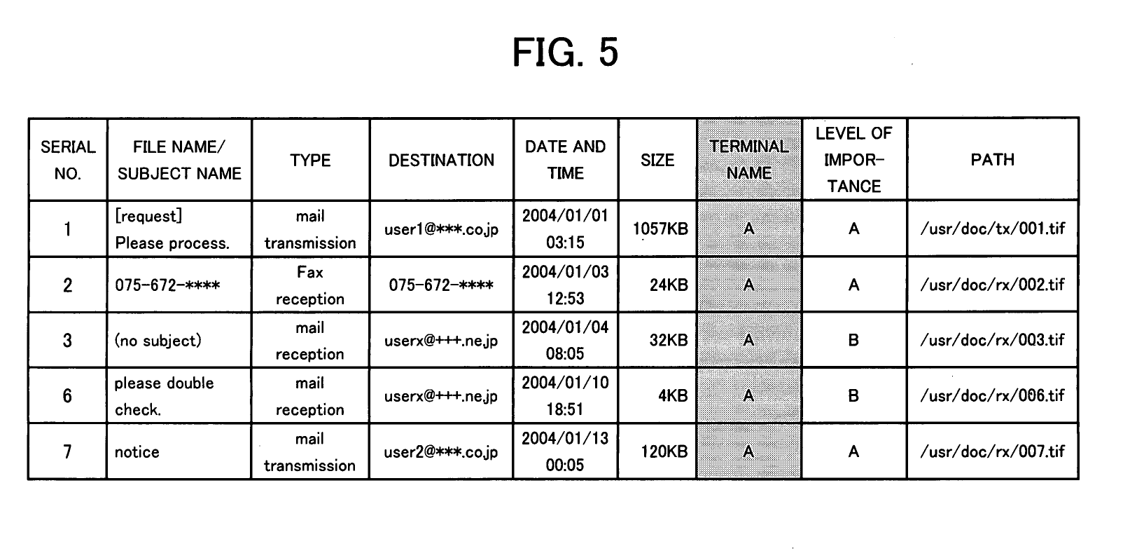

The file server 15 extracts the attribute information of the image file corresponding to the first extraction condition 17 from the file list stored in the file server 15. Specifically, the first extraction condition 17 has been transmitted to extract information other than the “terminal name” field for records with “A” written in the “terminal name” field. The file server 15 extracts information corresponding to the first extraction condition 17, in other words, information (attribute information) other than the “terminal name” for records with serial numbers “1”, “2”, “3”, “6” and “7” in which “A” is written in the “terminal name” field. Next, the file server 15 generates the first list including the extracted information. The first list in this case is a list having information of fields excluding the “terminal name” field (shaded part) of a list shown in FIG. 5. The file server 15 transmits the generated first list to the communication terminal device 1A that requested the first list.

Meanwhile, after requesting the transmission of the first list at step S2, the control unit 2 of the communication terminal device 1A determines whether or not the first list transmitted from the file server 15 has been received (step S3). When a determination is made that the first list has been received (step S3: YES), the control unit 2 retrieves information written in one record of the first list (step S4). Then, the control unit 2 determines whether or not the retrieved information of the one record corresponds to the second extraction condition 18 (step S5). Specifically, the control unit 2 retrieves information written in the “type” field of a record at a top the first list, and determines whether or not “mail reception” is written. Further, the “type” field is not the shaded part of the list shown in FIG. 5.

When the control unit 2 determines that the retrieved information of the one record corresponds to the second extraction condition 18 (step S5: YES), the control unit 2 determines whether or not a second list has been already generated (step S6). When a determination is made that the second list has not been generated (step S6: NO), the control unit 2 generates the second list (step S7). The control unit 2 extracts information specifying the image file corresponding to the second extraction condition 18 from the first list, and writes the extracted information into the second list (step S8). Specifically, when the control unit 2 retrieves the record of the serial number “3” in which “mail reception” is written in the “type” field, the control unit 2 generates the second list. Then, the control unit 2 extracts the serial number “3”, which is “information specifying the image file” corresponding to the second extraction condition 18, from the first list, and writes the extracted serial number “3” into the second list.

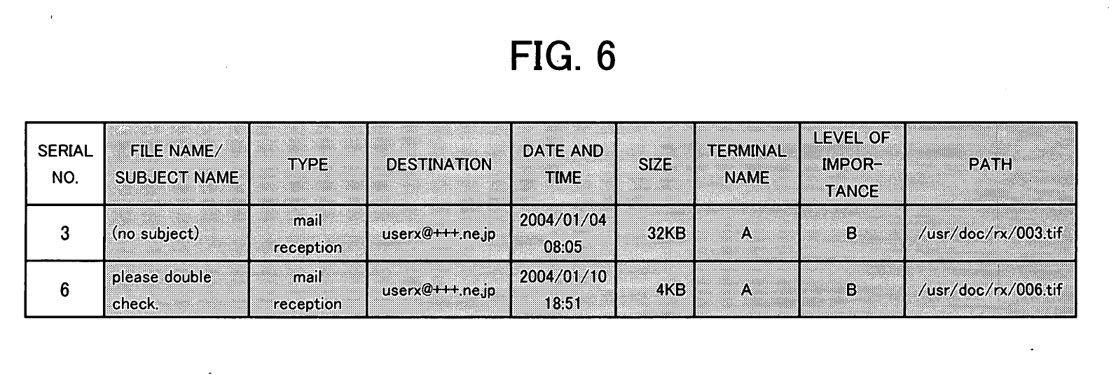

Meanwhile, when the control unit 2 determines that the second list has been already generated (step S6: YES), the control unit 2 skips the process of step S7 and carries out process of step S8 and onwards. Moreover, when a determination is made at step S5 that the retrieved information of the one record does not correspond to the second extracting condition 18 (step S5: NO), the processes of step S6 through step S8 are skipped. When a determination of “NO” is made at step S5, or when the process of step S8 is carried out, a determination is made as to a presence or an absence of a record in the first list that has not retrieved (step S9). When a determination is made that a record that has not been retrieved exists in the first list (step S9: YES), the process of step S4 is executed on such a record, and the subsequent processes are carried out. Specifically, after writing the serial number “3” into the second list, information of the records of the serial number “4” onwards continues to be retrieved from the first list. When the record of the serial number “6” in which “mail reception” is written in the “type” field is retrieved, the serial number “6” is written into the second list. The second list generated by series of the above-described processes is formed as a list in which a part of the “serial number” field (a part other than shaded parts) of a list shown in FIG. 6 is written.

When the control unit 2 determines at step S9 that no record exists in the first list that has not be retrieved, in other words, that information of all of the records of the first list has been retrieved (step S9: NO), a determination is made as to whether or not the second list has been generated (step S10). When a determination is made that the second list has not been generated (step S10: NO), the process ends. The control unit 2 determines “NO” at step S10, for example, when the second extraction condition 18 is designated to extract the “serial number” of the record in which “scan” is written in the “type” field. As shown in FIG. 5, the first list does not have a record in which “scan” is written in the “type” field. Therefore, the second list is not generated, and a determination is made that the second list has not been generated. Then, the process is ended.

On the contrary, when the control unit 2 determines that the second list has been generated (step S10: YES), the control unit 2 transmits the second list to the file server 15, and requests the file server 15 to execute the request processing 19, in other words, the “deletion processing”, on the image file specified by the second list (step S1). Specifically, the control unit 2 transmits to the file server 15, the second list and a command requesting a deletion of the image file specified by the second list.

Meanwhile, the file server 15 retrieves a “path” corresponding to the “serial number” written in the received second list from the file list. The file server 15 locks a DataBase (DB) record of the image file specified by the “serial number”. Then, the file server 15 accesses to a path where the image file is stored, and deletes the image file. After deleting the image file, the file server 15 deletes the DB record of the deleted image file. Further, when failing to lock the DB record or failing to delete the image file due to a reason such as the image file being used by another application, the file server 15 does not delete the image file and the DB record. Moreover, the DB record may be unlocked, and the process may be retried from the beginning. In case of a presence of an image file that failed to be deleted, such a fact may be notified from the file server 15 to the communication terminal device 1.

As described above, according to the embodiment of the present invention, the communication terminal device 1 can receive the first list without requiring the user to carry out an operation. The communication terminal device 1 can automatically acquire the attribute information of the image file stored in the file server 15. Moreover, without correcting the program of the file server 15 so as to execute the deletion processing, or without installing a program for executing the deletion processing, the image file specified by the second list can be deleted automatically without requiring the user to carry out an operation.

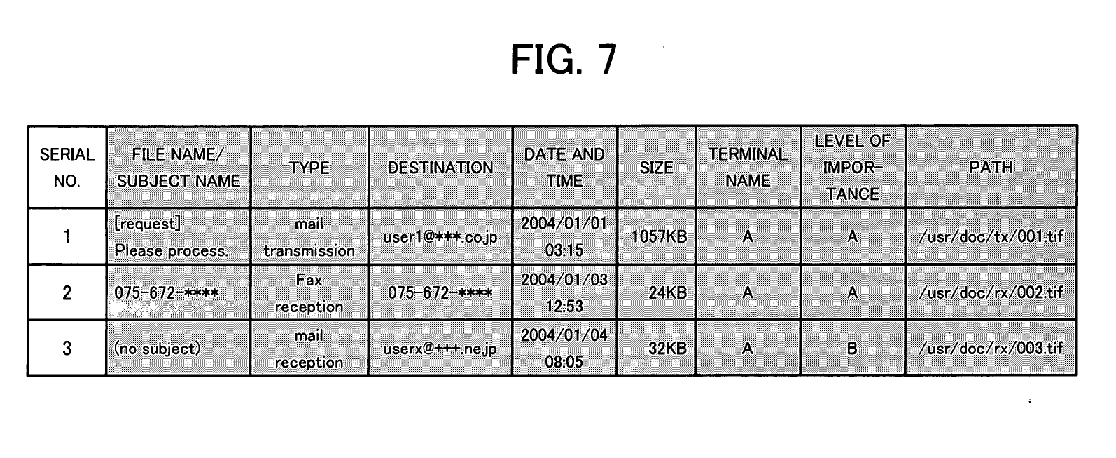

Further, in the above-described embodiment of the present invention, a description is made of an example in which the communication terminal device 1A requests the file server 15 to execute the deletion processing of the image file received in the form of electronic mail among the image files stored in the file server 15. However, the communication terminal device 1A can also request the execution of the deletion processing of the image file stored in the file server 15 under other various conditions. For example, among the image files stored in the file server 15, when the communication terminal device 1A requests the file server 15 to execute the deletion processing of an image file stored on or before Jan. 9, 2004, the second extraction condition 18 is designated to extract the “serial number” of a record in which “Jan. 9, 2004 or before” is written in the “date and time” field. The serial numbers “1” through “3” correspond to the second extraction condition 18. The second list is formed as a list having the “serial number” field of a list shown in FIG. 7.

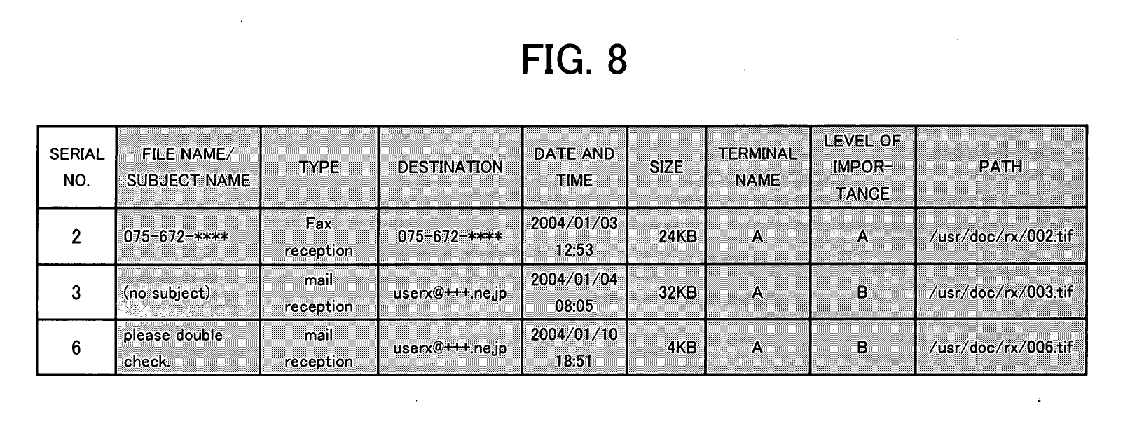

Moreover, among the image files stored in the file server 15, when the communication terminal device 1A requests the deletion processing of an image file received on or before Jan. 12, 2004, the second extraction condition 18 is designated to extract the “serial number” of a record in which “Jan. 12, 2004 or before” is written in the “date and time” file and “Fax reception” or “mail reception” is written in the “type” field. The second list is formed as a list having the “serial number” field of a list shown in FIG. 8 in which the serial numbers “2”, “3” and “6” are written. Further, the “serial number” is extracted as the “information specifying the image file” corresponding to the second extraction condition 18. However, the “path” or the like can be extracted as the “information specifying the image file” if the “path” or the like is the “information that can specify the image file”. The first list and the second list can be deleted after the end of the process, or can be stored to enable the user to confirm a history later.

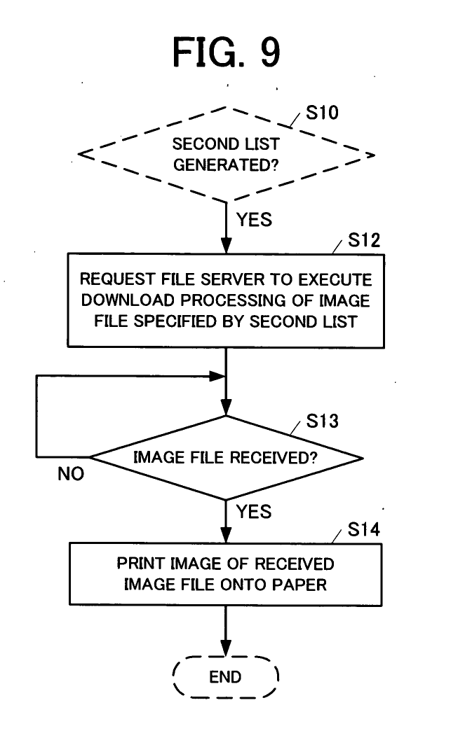

Next, a description will be made of a processing operation carried out when the request date and time 16 arrives. The description will be made with reference to an example of case where in the communication terminal device 1 (1A), the user presets the request date and time 16 at “7:00 AM of Monday Every Week”, the first extraction condition 17 is designated to extract “attribute information of an image file, which has been stored into the file server 15 by another device (terminals “B” and “C”: the communication terminal devices 1B and 1C), the second extraction condition 18 is designated to extract “information specifying an image file transmitted by Fax” from the first list, and the request processing 19 is designated to carry out a “download processing” of an image file specified by the second list. Since same processes are carried out up to the processes of step S10 of the flowchart shown in FIG. 4, a description will be omitted. A description will be made of processes carried out in place of the process of step S11 with reference to the flowchart of FIG. 9. The file server 15 is assumed to be storing the file list shown in FIG. 3 and an image file corresponding to the attribute information written in the file list. In this case, by series of the processes from step S1 through S10, the communication terminal device 1A has received from the file server 15, the first list including attribute information of fields other than the “terminal name” field for records in which “4” and “5” are written in the “serial number” field. In addition, the communication terminal device 1A has also generated the second list in which “5” is written in the “serial number” field.

When the control unit 2 determines at step S10 that the second list has been generated (step S10: YES), the control unit 2 transmits the second list to the file server 15, and requests the file server 15 to execute the request processing 19, in other words, the “download processing”, on the image file specified by the second list (step S12). Specifically, the control unit 2 transmits to the file server 15, the second list and a signal requesting a transmission of the image file specified by the second list.

On the contrary, the file server 15 retrieves a “path” corresponding to the “serial number” written in the received second list from the file list, and locks a DB record of the image file specified by the second list. The file server 15 accesses to the path where the corresponding image file is stored, and transmits the image file to the communication terminal device 1A that requested the image file. After the transmission is completed, the file server 15 unlocks the lock of the DB record.

Next, the control unit 2 of the communication terminal device 1A determines whether or not the image file from the file server 15 has been received (step S13). When the control unit 2 determines that the image file has been received (step S13: YES), the control unit 2 stores the received image file into the image memory 8, and prints out an image of the image file onto paper by the printer unit 12 (step S14). In this case, when the image file stored in the image memory 8 is encoded, the CODEC 5 decodes the encoded image data and converts the image data into binary data or multi-value data to generate print data. Then, the printer unit 12 prints out the image onto paper.

As described above, according to the embodiment of the present invention, without correcting the program of the file server 15 so as to execute the download processing, or without installing a program for executing the download processing, the communication terminal device 1A can transmit the image file specified by the second list without requiring the user to carry out an operation and can automatically print out the image of the image file onto paper.

Further, in the above-described embodiment, the image of the image file received by executing the download processing by the file server 15 is printed out onto paper. However, the present invention is not limited to this example in particular. For example, the received image file may be transmitted to another storage.

What is claimed is:

1. A communication terminal device connected to a file server, which stores an image file and attribute information of the image file by associating one with another, via a network in a manner that communication can be carried out, the communication terminal device comprising:
means for storing a first extraction condition and a second extraction condition;
a first requesting means for requesting the file server to transmit a first list having attribute information of an image file corresponding to the first extraction condition when a preset request date and time arrives;
means for receiving the first list transmitted from the file server according to the request;
means for generating a second list by extracting information specifying an image file corresponding to the second extraction condition from the received first list and writing the extracted information into the second list; and
a second requesting means for requesting the file server to execute a prescribed processing on an image file specified by the generated second list.

2. The communication terminal device according to claim 1, wherein the second requesting means requests the file server to execute a deletion processing on the image file specified by the generated second list.

3. The communication terminal device according to claim 1, wherein the second requesting means requests the file server to execute a download processing on the image file specified by the second list generated by the means for generating, and
the means for receiving receives an image file transmitted from the file server according to the request of the second requesting means in addition to the first list.

4. The communication terminal device according to claim 3, further comprising means for printing an image of the image file received by the means for receiving onto paper.

5. The communication terminal device according to claim 1, further comprising means for accepting a designation of the first extraction condition and the second extraction condition,
wherein the means for storing stores the first extraction condition and the second extraction condition accepted by the means for accepting.

6. The communication terminal device according to claim 2, further comprising means for accepting a designation of the first extraction condition and the second extraction condition,
wherein the means for storing stores the first extraction condition and the second extraction condition accepted by the means for accepting.

7. The communication terminal device according to claim 3, further comprising means for accepting a designation of the first extraction condition and the second extraction condition,
wherein the means for storing stores the first extraction condition and the second extraction condition accepted by the means for accepting.

8. The communication terminal device according to claim 4, further comprising means for accepting a designation of the first extraction condition and the second extraction condition,
wherein the means for storing stores the first extraction condition and the second extraction condition accepted by the means for accepting.

9. A method for controlling a communication terminal device, comprising:
a step of establishing a connection between the communication terminal device and a file server, which stores an image file and attribute information of the image file by associating one with another, via a network in a manner that communication can be carried out;
a step of storing a first extraction condition and a second extraction condition;
a first requesting step of requesting the file server to transmit a first list having attribute information of an image file corresponding to the first extraction condition when a preset request date and time arrives;
a step of receiving the first list transmitted from the file server according to the request;
a step of generating a second list by extracting information specifying an image file corresponding to the second extraction condition from the received first list and writing the extracted information into the second list; and
a second requesting step of requesting the file server to execute a prescribed processing on an image file specified by the generated second list.

10. The method for controlling the communication terminal device according to claim 9, wherein the second requesting step requests the file server to execute a deletion processing on the image file specified by the generated second list.

11. The method for controlling the communication terminal device according to claim 9, wherein the second requesting step requests the file server to execute a download processing on the image file specified by the second list generated at the step of generating, and
the step of receiving receives an image file transmitted from the file server according to the request at the second requesting step in addition to the first list.

12. The method for controlling the communication terminal device according to claim 11, further comprising a step of printing an image of the image file received at the step of receiving onto paper.

13. The method for controlling the communication terminal device according to claim 9, further comprising a step of accepting a designation of the first extraction condition and the second extraction condition,
wherein the step of storing stores the first extraction condition and the second extraction condition accepted at the step of accepting.

14. The method for controlling the communication terminal device according to claim 10, further comprising a step of accepting a designation of the first extraction condition and the second extraction condition,
wherein the step of storing stores the first extraction condition and the second extraction condition accepted at the step of accepting.

15. The method for controlling the communication terminal device according to claim 11, further comprising a step of accepting a designation of the first extraction condition and the second extraction condition,
wherein the step of storing stores the first extraction condition and the second extraction condition accepted at the step of accepting.

16. The method for controlling the communication terminal device according to claim 12, further comprising a step of accepting a designation of the first extraction condition and the second extraction condition,
wherein the step of storing stores the first extraction condition and the second extraction condition accepted at the step of accepting.
